(19) United States
(12) Patent Application Publication
(10) Pub. No.: US 2019/0362169 A1
(43) Pub. Date: Nov. 28, 2019

(54) METHOD FOR VERIFYING USER IDENTITY AND AGE

(71) Applicant: GOOD COURAGE LIMITED, Grand Cayman (KY)

(72) Inventors: Heng-Yi LIN, Taipei City (TW); Eric TANG, Grand Cayman (KY); Hua CHENG, Grand Cayman (KY)

(21) Appl. No.: 15/990,036

(22) Filed: May 25, 2018

(51) Int. Cl. G06K 9/00; G06Q 30/06

(52) U.S. Cl. CPC G06K 9/00892; G06Q 30/0607; G06K 9/00288; G06K 9/00469; G06K 9/00255

(57) ABSTRACT

A method for verifying user identity and age includes: using a front camera to receive a frontal image of a human face; using a rear camera to receive an image of an identification document, from which a headshot and a date of birth code are extracted; determining whether there is a coincidence or not by comparing the face image and the headshot; determining whether an age value, calculated by comparing the date of birth code and a current date, is greater than or equal to a threshold value; when the face image coincides the headshot and the age value is larger than or equal to the threshold value, the verification is passed and an online transaction proceeds; when the face image is not consistent with the headshot or the age value is smaller than the threshold value, the verification fails and the online transaction is terminated.

### BACKGROUND OF THE INVENTION

### 1. Field of the Invention

The present invention relates to a verification method, and in particular, to a verification method for user identity and age.

### 2. Description of the Prior Arts

With the rapid development of intelligent mobile devices and e-commerce, people of all ages each have at least one smart mobile device, and as online shopping is quite popular, any user can use his/her smart mobile device to connect and to log into a shopping host, the shopping host serves as a medium of the online transactions between the consumers and the suppliers to allow the consumers to do online shopping anytime, anywhere; through online shopping, the consumers can buy various kinds of merchandizes, including those that have a statutory age limit, such as tobacco and alcoholic beverages, etc.

However, a consumer needs only an account and a password to log into the shopping host. In other words, the shopping host verifies the consumer's identity only through the account and password, as long as the account and password are verified, even an under-age consumer can purchase tobacco and alcoholic beverages through operating a smart mobile device. It is clear from the aforementioned, the verification procedure using only account and password is neither sufficient nor effective to comply with the governmental regulations.

### SUMMARY OF THE INVENTION

In view of the above, the main purpose of the present invention is to provide a method for verifying user identity and age to overcome the insufficiency of the present technology of authentication in verifying identify only through the account and password.

The present invention provides a method for verifying user identity and age, executed on a mobile device which includes a front camera and a rear camera and connects to a server to perform an online transaction, and the method comprises the steps as follows: taking a photograph of a user's face to receive a human face's frontal image by the front camera; taking a photograph of a physical identification document by the rear camera to receive an image of the identification document; analyzing the image of the identification document to extract a headshot and a birthday code; comparing the human face's frontal image and the headshot to determine whether there is a coincidence or not; calculating an age value based on the birthday code and a current date, so as to determine whether the age value is greater than or equal to a threshold value; when the human face's frontal image and the headshot coincide, plus the age value is greater than or equal to the threshold value, then the verification is passed and the online transaction proceeds; when the human face's frontal image and the headshot do not coincide or the age value is smaller than the threshold value, then the verification fails and the online transaction is terminated.

The verifying method of the present invention has the following functions and effects.

The front camera and the rear camera are the basic equipment for the mobile device, so the verification method can be widely applied on mobile devices on the market.

The present invention, through a mobile device, takes photographs for a user and a physical identification document, thereby the photographed frontal image of the user and the photographed image of the identification document are bound together for verifying whether or not the user and the headshot on the identification document are the same person, thus avoiding fraud of the physical identification document by other users.

The present invention calculates an age value based on the date of birth code and a present date, and thus, the calculated age value is the actual age of the user's, which serves as an objective basis for judging the age, then, and when the age value is smaller than the threshold value, the online transaction will be terminated, thus effectively preventing the consumers who do not meet the statutory age limit from purchasing merchandise that they are not eligible to buy.

### BRIEF DESCRIPTION OF THE DRAWINGS

FIG. 1 shows a block diagram of a mobile device of the present invention's verifying method;

FIG. 2 shows a flow chart of an embodiment, of the present invention's verifying method;

FIG. 3 shows a diagram that illustrates a mobile device's front camera and rear camera which are used respectively in taking photographs of a user's face and a physical identification document in the present invention;

FIG. 4 shows a diagram illustrating the photographed image of a physical identification document in the present invention; and

FIG. 5 shows a diagram illustrating the photographed image of a passport.

### DETAILED DESCRIPTION OF THE PREFERRED EMBODIMENTS

The technical solutions of the present invention are described in detail below, with reference to the accompanying drawings.

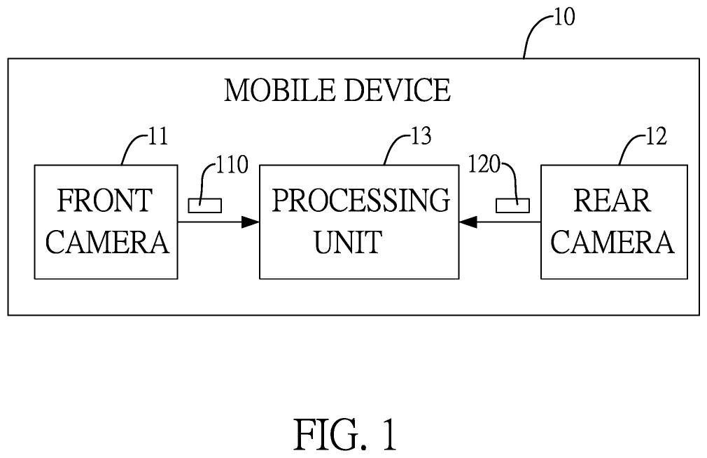

Referring to FIG. 1, a method of the present invention for verifying user identity and age may be executed on a mobile device 10, which may be a smart mobile device, such as a smart phone or a tablet PC, but not limited thereto. The mobile device 10 includes a front camera 11, a rear camera 12, and a processing unit 13 which may be the CPU connected to the front camera 11 and the rear camera 12, for executing an application program (App) embodied in the present invention's verifying method. The front camera 11 and the rear camera 12 are disposed at opposite sides of the mobile device 10, when the mobile device 10 is operated by a user, the front camera 11 is positioned toward the user and the rear camera 12 is positioned away from the user.

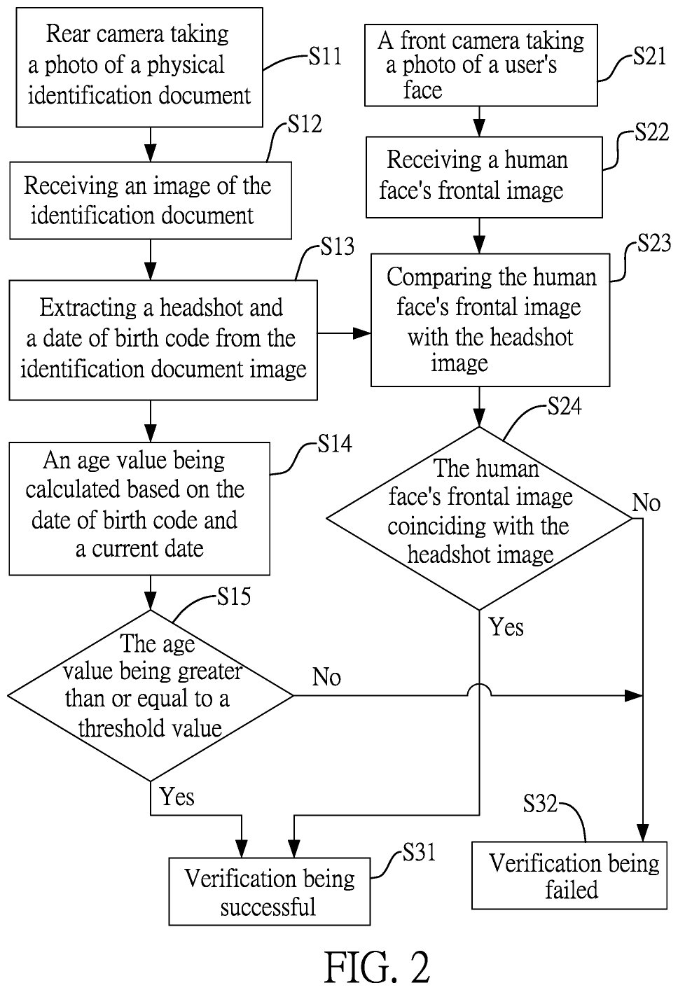

The mobile device 10 may be connected to a server via the Internet for an online transaction. Referring to FIGS. 1 and 2, an embodiment of the present invention's verifying method is explained as follows:

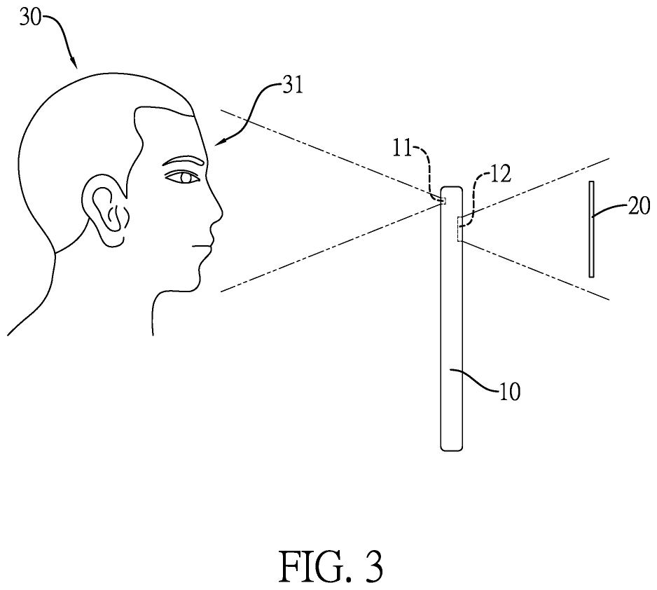

The rear camera 12 takes a photograph of a physical identification document (Step S11) to receive an image of the identification document (step S12); the front camera 11 takes a photograph of the face 31 of a user 30 (step S21) to receive a human face's frontal image 110 (step S22), wherein, referring to FIG. 3, the user 30 may hold the mobile device 10 and turn the front camera 11 toward the front side of the face 31 for photographing, and turn the rear camera 12 toward the physical identification document 20 for photographing. The obtained human face's frontal image 110 and the document image 120 are all digital images. For example, the physical identification document 20 may be a passport, an identity card, a driver's license, a health insurance card, etc., but not limited thereto. Since the formats of the physical identification document 20 are official, the formats for the headshot, name field, date of birth field, ID number field, etc. are fixed, and the photographed part of the physical document 20 contains the headshot and the date of birth, or may further contain an ID number (ID).

The identification document image 120 and the human face's frontal image 110 can be taken at the same time by the mobile device 10 that supports the front camera 11 and the rear camera 12 which can take photographs simultaneously. For a mobile device 10 that does not support the front camera 11 and the rear camera 12 taking photographs at the same time, the application program may first direct the user 30 to photograph the human face's frontal image 110 through the front camera 11, and after receiving the human face's frontal image 110, the application program directs the user 30 to photograph the identification document image 120 through the rear camera 12 within a time limit (for example, several seconds); similarly, the application program may first direct the user 30 to photograph the identification document image 120 through the rear camera 12, and then within the time limit, photograph and receive the human face's frontal image 110 through the front camera 11.

Upon obtaining the identification document image 120, the document image 120 is analyzed to extract a headshot and a date of birth code from the document image 120 or to further extract an identity number (Step S13); it is to be noted that extracting part of the image or text from the image is general knowledge in the field of image processing technology. For example, the mobile device 10 may store in advance or may download from the Internet the information of identification document formats of various countries or various types, each identification document format's information can be based on the boundaries of the identification document image 120 to cut and to locate the positions of the headshot, the date of birth and ID number fields, and through the means of optical characters recognition (OCR), characters can be extracted from the identification document image 120. Therefore the characters recognized in the date of birth field are the date of birth, and the characters identified in the ID number field are the ID number.

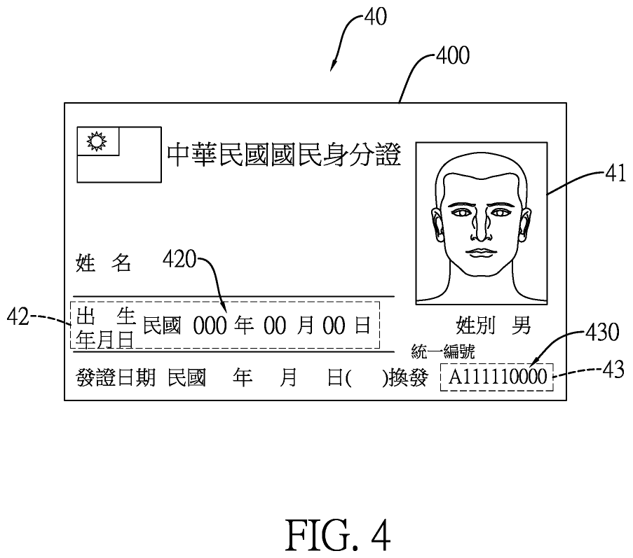

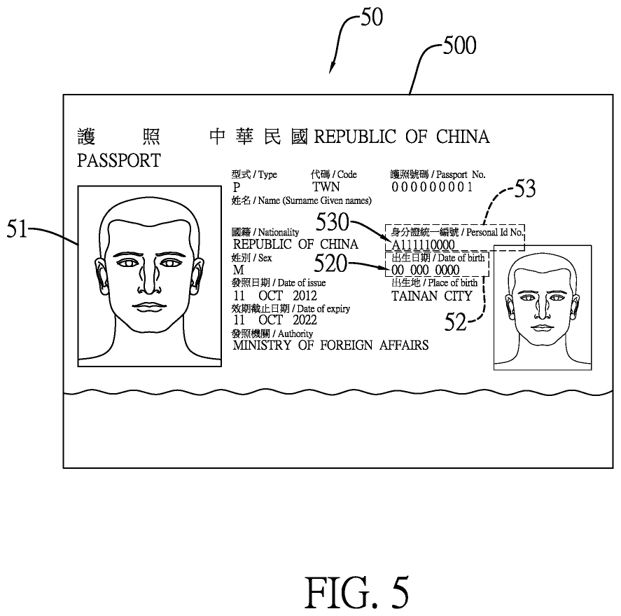

Hereinafter, the processing of the image of the identification document will be described with examples. With reference to FIG. 4, taking the ID card image 40 of the Republic of China as an example of the identification document image, after detecting its boundary 400, the headshot image 41, the date of birth field 42, and the identity number field 43 can be located. Moreover, the date of birth code 420 and the identity number 430 are recognized. Referring to FIG. 5, taking the passport image 50 of the Republic of China as an example, after detecting its boundary 500, the headshot image 51, the date of birth field 52, and the ID number field 53 can be located. Furthermore, the identification date code 520 and the identification number 530 are recognized.

After recognizing the date of birth code, an age value is calculated based on the date of birth code and a current date (step S14), that is, the difference between the current date and the date of birth is defined as the age value. The current date is synchronized from the Internet, e.g., the mobile device 10 may be connected to a server through the Internet to synchronize the current date via the server, or the current date may be the date generated by the mobile device 10's own clock program.

After calculating the age value, it is determined whether or not the age value is greater than or equal to a threshold value (step S15), wherein the threshold value may either be a value preset in the application program, or an updated value downloaded from a server. When it is determined that the age value is greater than or equal to the threshold value, then the age indicated by the identification document image 120 satisfies one condition. On the other hand, according to FIG. 2, the present invention compares the human face's frontal image with the headshot image (step S23) to further determine whether or not the human face's frontal image coincides with the headshot image (step S24), wherein, the means for human face images comparison is common knowledge in the field of image processing technology. For example, referring to FIGS. 1 and 4, after acquiring the human face's frontal image 110 and the headshot image 41, the corresponding features of the human face's frontal image 110 and the headshot image 41 are extracted for similarity analysis, when the similarity between the human face's frontal image 110 and the headshot image 41 is higher than or equal to a threshold percentage value, it is determined that the face frontal image 110 coincides with the headshot image 41, and the user indicated by the identification document image 120 is initially checked to be the same person as the user who took the picture at step S21.

As mentioned earlier, when the age value is greater than or equal to the threshold value and the human face's frontal image coincides with the headshot image, both judgment results thereof are required to be positive (Step S31) for the network transaction to proceed; conversely, when the age value is less than the threshold value, or the human face's image is not consistent with the headshot image (i.e., if the similarity value between the two images is lower than the threshold percentage value.), either one of the judgment results thereof is required to be negative for the verification to fail (step S32), thereby the network transaction is terminated. In addition to the initial identification of the user identity through the human face recognition, the present invention can further determine whether or not the identity number 530 recognized in step S13 qualifies, so as to further provide anti-forgery effects. Take the ID card of the Republic of China as an example, which follows some standardization that allows the application program to execute a checking procedure for the ID number of the ID card to determine whether the identity number 530 is acceptable. If not, it may indicate that the physical identification document is a forged one and the verification fails.

In summary, for example, the user 30 may operate the mobile device 10 to connect to a server of a wine supplier to purchase alcoholic goods online. As the consumer who purchases the alcoholic goods may be restricted by a statutory age limit; the threshold value in step S15 may be, for example, 18 years old. When the age value calculated in step S14 is greater than or equal to 18 years old, it means that the age indicated by the identification document image 120 has reached the statutory age eligible to purchase alcoholic goods; on the contrary, when the calculated age value is less than 18 years old, it means that the age indicated by the identification document image 120 does not yet reach the statutory age eligible to purchase alcoholic goods, and the verification fails and the step of purchasing alcoholic goods is terminated. On the other hand, the present invention also uses the means of human face recognition to determine if the user and the headshot image of the physical identification document coincide or not; if not, the verification also fails.

In addition to the above-mentioned actions of purchasing alcoholic goods, the present invention can also be carried out in an age-restricted online transaction, such as using the mobile device 10 to purchase tobacco products, to rent cars, to purchase cars, and so on.

What is claimed is:

1. A method for verifying user identity and age, executed by a mobile device which includes a front camera and a rear camera and connects to a server to perform an online transaction, the method comprising the steps of:
taking a photograph of a user's face to receive a human face's frontal image by the front camera;
taking a photograph of a physical identification document to receive an image of the identification document by the rear camera;
analyzing the image of the identification document to extract a headshot and a date of birth code;
comparing the human face's frontal image and the headshot to determine whether there is a coincidence or not;
calculating an age value based on the date of birth code and a current date, so as to determine whether the age value is greater than or equal to a threshold value;
when the human face's frontal image and the headshot coincide, plus the age value is greater than or equal to the threshold value, then the verification is passed and the online transaction proceeds;
when the human face's frontal image and the headshot do not coincide, or the age value is smaller than the threshold value, then the verification fails and the online transaction is terminated.

2. The method for verifying user identity and age as claimed in claim 1, wherein, in the step of determining whether the age value is greater than or equal to a threshold value, the threshold value is a preset value.

3. The method for verifying user identity and age as claimed in claim 1, wherein, in the step of determining whether the age value is greater than or equal to a threshold value, the threshold value is a downloaded updated value.

4. The method for verifying user identity and age as claimed in claim 1, wherein, in the step of calculating an age value based on the date of birth code and a current date, the current date is synchronized from the Internet.

5. The method for verifying user identity and age as claimed in claim 1, wherein, in the step of calculating an age value based on the date of birth code and a current date, the current date is the date generated by the mobile device's own clock program.

6. The method for verifying user identity and age as claimed in claim 1, wherein the step of analyzing the image of the identification document further comprises: extracting an identity number and determining if the identity number qualifies, if not, then the verification fails.

7. The method for verifying user identity and age as claimed in claim 1, wherein, the front camera and the rear camera simultaneously take photographs to receive the image of the identification document and the human face's frontal image.

8. The method for verifying user identity and age as claimed in claim 2, wherein, the front camera and the rear camera simultaneously take photographs to receive the image of the identification document and the human face's frontal image.

9. The method for verifying user identity and age as claimed in claim 4, wherein, the front camera and the rear camera simultaneously take photographs to receive the image of the identification document and the human face's frontal image.

10. The method for verifying user identity and age as claimed in claim 6, wherein, the front camera and the rear camera simultaneously take photographs to receive the image of the identification document and the human face's frontal image.

11. The method for verifying user identity and age as claimed in claim 1, wherein, after the human face's frontal image is received, the image of the identification document is to be received within a time limit.

12. The method for verifying user identity and age as claimed in claim 2, wherein, after the human face's frontal image is received, the image of the identification document is to be received within a time limit.

13. The method for verifying user identity and age as claimed in claim 4, wherein, after the human face's frontal image is received, the image of the identification document is to be received within a time limit.

14. The method for verifying user identity and age as claimed in claim 6, wherein, after the human face's frontal image is received, the image of the identification document is to be received within a time limit.

15. The method for verifying user identity and age as claimed in claim 1, wherein, after the image of the identification document is received, the human face's frontal image is to be received within a time limit.

16. The method for verifying user identity and age as claimed in claim 2, wherein, after the image of the identification document is received, the human face's frontal image is to be received within a time limit.

17. The method for verifying user identity and age as claimed in claim 4, wherein, after the image of the identification document is received, the human face's frontal image is to be received within a time limit.

18. The method for verifying user identity and age as claimed in claim 6, wherein, after the image of the identification document is received, the human face's frontal image is to be received within a time limit.

19. The method for verifying user identity and age as claimed in claim 1, wherein, the mobile device is a smart phone or a tablet personal computer.

20. The method for verifying user identity and age as claimed in claim 2, wherein, the mobile device is a smart phone or a tablet personal computer.
